(19) United States
(12) Patent Application Publication
(10) Pub. No.: US 2006/0193712 A1
(43) Pub. Date: Aug. 31, 2006

(54) FASTENER FOR A FAUCET

(75) Inventors: Rafal Kuna, Jarfalla (SE); Stanislaw Klaczany, Stockholm (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: KUNA GROUP AB, Jarfalla (SE)

(21) Appl. No.: 11/307,749

(22) Filed: Feb. 21, 2006

Related U.S. Application Data
(60) Provisional application No. 60/593,930, filed on Feb. 25, 2005.

(30) Foreign Application Priority Data
Feb. 25, 2005 (SE) 0500437-9

(51) Int. Cl. F16B 21/00

(52) U.S. Cl. 411/340

(57) ABSTRACT

The invention relates to a fastener for a faucet having an axially extending externally threaded fluid connection pipe arranged to be introduced into a hole in a support from the faucet side of said surface, and an internally threaded element arranged to co-act with the externally threaded pipe on the opposite side of said support, wherein a guide sleeve (20) arranged to be introduced in said (32) hole from the faucet side (52) of the support (30), and comprising stop means (26) arranged to co-act with the support (30), and an internally threaded member (10) arranged to be introduced into and guided by said sleeve (20) and to receive the externally threaded pipe (40), said internally threaded member (26) comprising snap means (16) arranged to snap out on said opposite side (54) of the support (30) when fastening the faucet (50).

### TECHNICAL FIELD

The present invention relates to a fastener for a faucet having an axially extending externally threaded fluid connection pipe arranged to be introduced into a hole in a support from the faucet side of the support.

### BACKGROUND

Various number of faucets, particularly water faucets, are known from prior art. Faucets utilizing both hot and cold water of an endless number of different designs, and also different variants of faucets used in connection with water purification devices providing cold water of high purity.

A general problem with faucet devices according to the prior art is the installation process. In a traditional installation of a water faucet device the problem lies in attaching the faucet to a sink unit or the like. The problem relates to the fact that, after having drilled a hole in the sink unit, the faucet must be fastened by means of a screw nut which is mounted from underneath. The threaded connection pipe of the faucet is introduced into the hole in the sink unit and then a screw nut is supposed to be screwed on from underneath at the same time as it is necessary to hold the faucet in place on the upper side in order to prevent the faucet from turning and end up in an undesired position. The fact that part of the attachment has to be done from underneath the sink unit, where usually the sink is protruding making it very narrow and consequently offering very little space to the installer, makes the working position very uncomfortable. The installer has to lie on the back in there with the arms stretched upwardly trying to pull the screw nut in a narrow cavity, which is ergonomically bad, and the risk for injuries is apparent. It is further impossible to alone hold the faucet on the sink unit at the same time as pulling the screw nut from underneath. Consequently this has to be done either by pulling and releasing a number of times before the faucet is fastened with the correct force and points in the correct direction, or by being two persons performing the task. The task is thus quite complicated, usually requiring a professional plumber, or at least a quite handy person.

### OBJECTS OF THE INVENTION

An object of the present invention is to provide a fastener which simplifies installation of a faucet device.

### SUMMARY OF THE INVENTION

These and other objects, apparent from the following description, are achieved by a fastener for a faucet having an axially extending externally threaded fluid connection pipe arranged to be introduced into a hole in a support from the faucet side of the support, said fastener comprising:

a guide sleeve arranged to be introduced into said hole from the faucet side of the support, and having stop means arranged to co-act with the support, and an internally threaded member arranged to be introduced into and guided by said sleeve and to receive and engage the threads of the externally threaded pipe, said internally threaded member comprising snap means arranged to snap out on the opposite side of the support from said faucet.

By having a fastener comprising a guide sleeve arranged to be introduced in said hole from the faucet side of the support, and comprising stop means arranged to co-act with the support, and an internally threaded member arranged to be introduced into and guided by said sleeve and to receive the externally threaded pipe, said internally threaded member comprising snap means arranged to snap out on said opposite side of the support when fastening the faucet, the installation of a faucet device is simplified in that the installation can be done from the faucet side alone. The installer does not have to crawl under the faucet support, minimizing the risk for injuries. It is further easier to direct the position of the faucet housing as there is no need to do this from both the faucet side and the opposite side of the support. Further the installation can be done in much less time and with much less effort. The likelihood of a layman being able to perform the installation is highly increased.

### DESCRIPTION OF THE DRAWINGS

A better understanding of the present invention will be had upon the reference to the following detailed description when read in conjunction with the accompanying drawings, wherein like reference characters refer to like parts throughout the several views, and in which:

FIG. 1 shows an exploded perspective view of the fastener according to the preferred embodiment of the present invention.

FIG. 2 shows a perspective view of the fastener in FIG. 1.

FIG. 3 shows a perspective view of the fastener in FIG. 1, to be introduced into a hole in a support.

FIG. 4 shows a perspective view of the fastener in FIG. 1, introduced into a hole in a support.

FIG. 5 shows a perspective view of the fastener in FIG. 1, introduced into a hole in a support, and a portion of a faucet, a fluid connection pipe, which is to be introduced into the fastener.

FIG. 6 shows a perspective view of the fastener in FIG. 1, introduced into a hole in a support, and a faucet being connected thereto.

FIG. 7 shows a perspective view of the fastener in FIG. 1, introduced into a hole in a support, and a faucet connected thereto.

### DETAILED DESCRIPTION OF THE INVENTION

The invention is intended to be used for faucets having an axially extending externally threaded water connection pipe, which today exist on all faucets.

The orientation of the main axis of the fastener is assumed to be vertical, i.e. it is assumed that the faucet/spout is intended to be vertically mounted, but other orientations are not excluded.

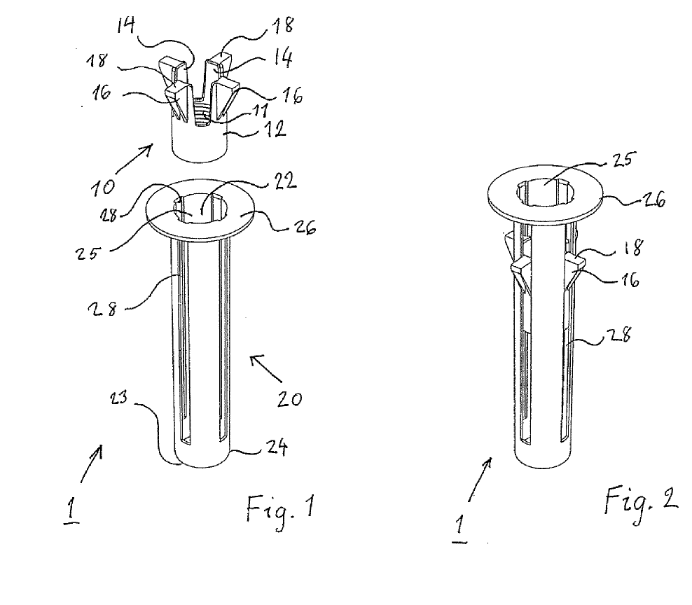

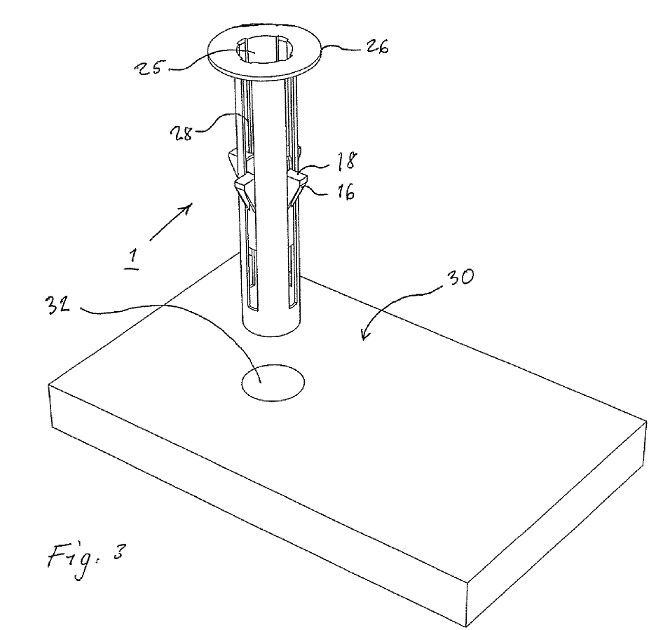

FIGS. 1 and 2 show perspective views of the fastener according to a preferred embodiment of the present invention. The fastener 1 comprises a snap ring 10, a guide sleeve 20, and preferably a rubber packing (not shown). The snap ring 10 is constituted by an internally threaded 11 element 10 having a hollow substantially circular cylindrical main body 12. The body has axially extending resilient protrusions 14, preferably four, evenly distributed along its circumference. Each protrusion 14 has a wing-shaped snap member 16 forming a substantially flat friction surface 18 protruding radially outwardly from the body 12. The snap ring 10 is preferably made of flexible, hard and resistant plastic, or other suitable material with similar characteristics, while the upper horizontal surfaces 18 of the four snap members 16 preferably are made of a soft elastomer, i.e. having rubber like characteristics, or other suitable material with similar characteristics, thus offering high friction when supported against another surface.

The guide sleeve 20 has an elongated cylindrical shape having a substantially circular hole 22 in the axial direction thereof, having a blocking surface 23 at the end 24 opposite to the opening end 25 for preventing insertion past that end 24. The opening end 25 has a stop member 26, preferably a flange 26 surrounding the hole 22 for supporting the fastener when introduced in a hole in e.g. a sink unit. The guide sleeve 20 comprises longitudinal slots 28, of the same number as the snap members 16, i.e. preferably four. Each slot 28 is arranged to receive a corresponding snap member 16. The snap ring 10 is arranged and dimensioned to fit in the hole 22 of the guide sleeve 20 and is further intended to be inserted through the opening end 25 of the guide sleeve 20, with the internally threaded main body 12 entering first. The resilient snap members 16 are arranged to fit in the slots 28 when the snap ring 10 is introduced in the opening 25. The slots 28 are arranged such that when the snap members 16 are slid passed the flange 26 they snap out through the slots 28. The slots 28 are further arranged such that the snap ring 10 may slide freely between the flange 26 and the blocking surface 23.

The rubber packing (not shown) is intended to cover the flange 26, for protection against wear and to increase friction.

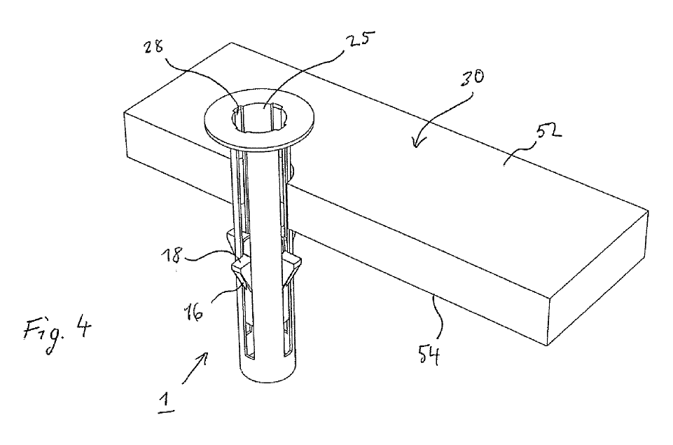

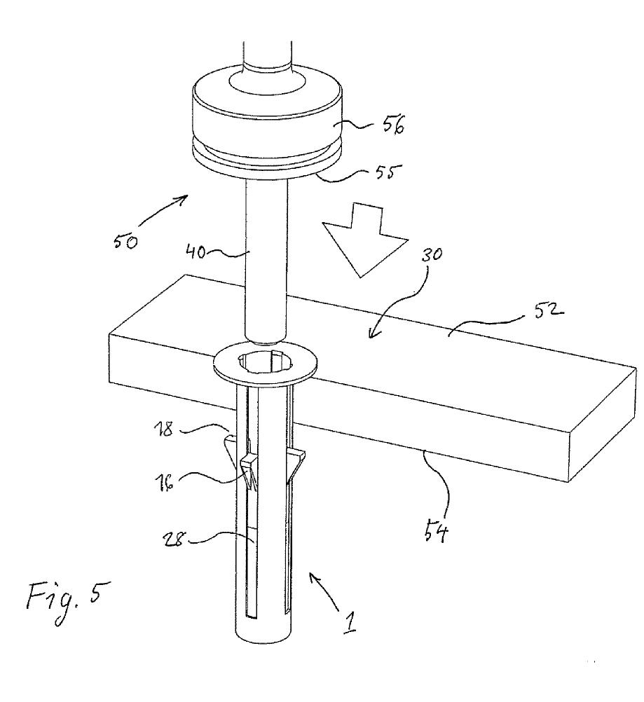

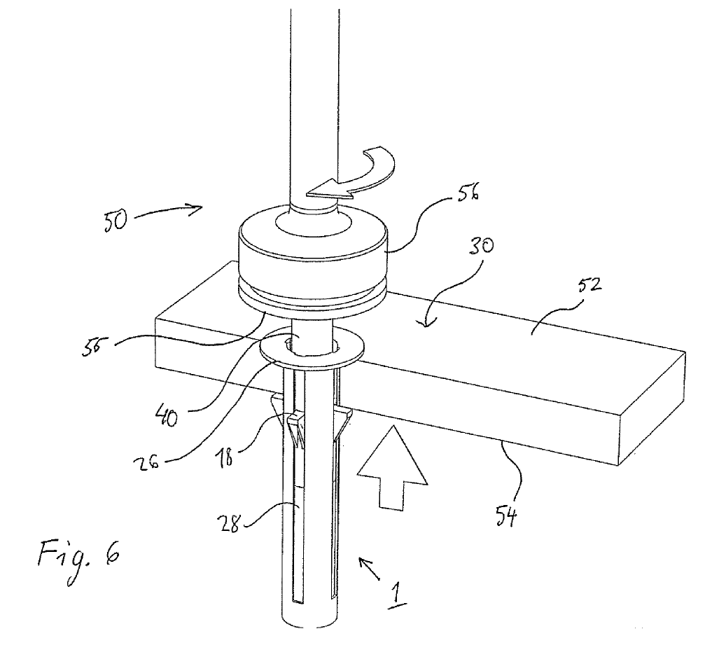

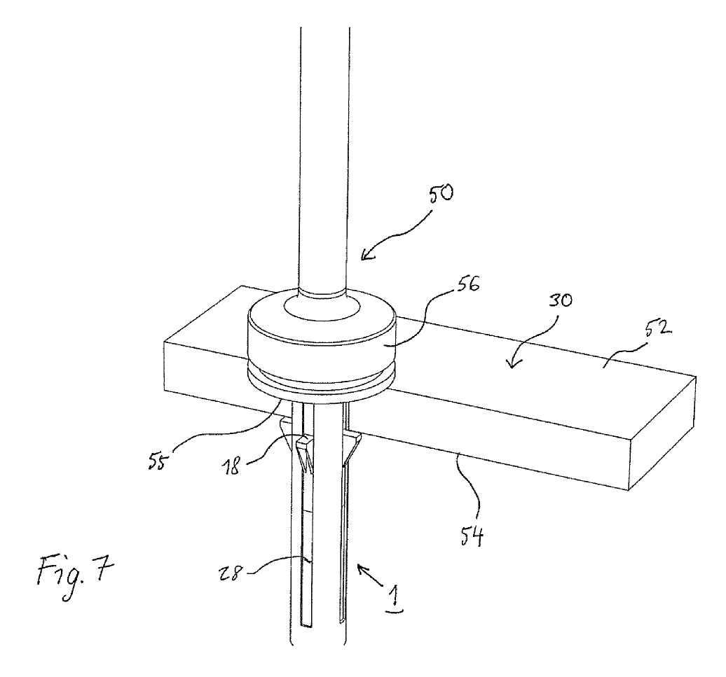

As mentioned above the fastener 1 according to the present invention is intended to be used for faucets having an axially extending externally threaded water connection pipe. The thread present internally in the main body 12 of the snap ring 10 corresponds to the thread present at the water connection pipe 40 of the faucet 50, which is intended to be screwed into the same. The working procedure for fastening a faucet device 50 on a support 30 by means of the present invention is explained below and shown in FIGS. 1-7.

Firstly a suitable hole 32 is drilled in the support 30, which could be a sink unit or the like. The hole is dimensioned such as to receive the elongated cylindrical portion 27 of the guide sleeve 20 but not allowing the flange 26 of the guide sleeve 20 there through, i.e. having a diameter slightly larger than the diameter of the cylindrical portion 27, but smaller than the diameter of the flange 26.

The snap ring 10 is introduced in the guide sleeve 20 such that the snap members 16 snap through the corresponding slots 28 as explained above. The flange 26 is covered with the rubber packing. The fastener 1 is then introduced into the hole 32 in the support 30 from the faucet side 52 until it is stopped by the flange 26 which functions as a support against the support 30. As the fastener 1 is introduced in the hole 32 the snap ring 10 remains in the level of the opening 25, i.e. slides along the slots 28, and the snap members 16 are flexed inwardly as the flange 26 reaches the support 30. The snap ring 10 is thus biased in the opening of the hole.

The externally threaded water connection pipe 40 of the faucet 50 is then introduced through the opening 25 and into the snap ring 10. The resistance from the biasing force of the snap members 16 against the wall of the hole 22, and the slots 28 in which the snap members 16 are located may be enough to allow connection between the pipe 40 and the snap ring 10 such that the externals threads of the pipe 40 are treaded in the internal threads of the snap ring 10. Would the snap ring 10 be pushed through the opening 25 and slide downwardly in the slots 28 prior to this connection it will come to a halt at the blocking surface 23 of the guide sleeve 20, and the thread connection will be made at that position instead. Whether the snap members snap out prior to co-action between the internally threaded element 10 and the externally threaded pipe 40 may depend on the thickness of the support 30, i.e. it is more likely that the snap members snap out when introduced through a hole in a thin support 30. It however does not influence the fastening procedure.

The snap ring 10 is anyway pushed through the hole to the opposite side of the faucet side such that the snap member 16 snap out through the slots 28. The water connection pipe 40 is threaded into the snap ring 10 by turning the faucet 50 about its own vertical axis. When a threaded connection is made the faucet 50 is pulled upwardly such that the elastomer friction surfaces 18 of the snap members 16 are brought in contact with the surface on the side 54 opposite to the faucet side 52 of the support and thereby creates friction. In this position the faucet 50 is continued to be pulled about its axis such that the surface 55 of the faucet housing 56 facing the faucet side 52 of the support 30 is brought in contact with the support 30, at which moment the further pulling is performed until the surface 55 of the faucet housing 56 fits tightly against the support 30. The position, i.e. direction, of the faucet 50 is easily done by directing the guide sleeve 20 prior to pulling the faucet 50.

In this way the faucet can be mounted on a support, e.g. a sink unit, without having had to work under the support.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

What is claimed is:

1. Fastener for a faucet having an axially extending externally threaded fluid connection pipe arranged to be introduced into a hole in a support from the faucet side of the surface, said fastener comprising:
a. a guide sleeve arranged to be introduced into said hole from the faucet side of the support, and having stop means arranged to co-act with the support,
b. and an internally threaded member arranged to be introduced into and guided by said sleeve and to receive and engage the threads of the externally threaded pipe, said internally threaded member comprising snap means arranged to snap out on the opposite side of the support from said faucet.

2. Fastener according to claim 1, wherein said guide sleeve comprises axially extending slots arranged to guide said internally threaded member.

3. Fastener according to claim 2, wherein said snap means comprise resilient wing-shaped members arranged to be received in said slots.

4. Fastener according to claim 3, wherein the number of slots correspond to the number of wing-shaped members, preferably being four, and that each wing-shaped member is arranged to be received in a corresponding slot.

5. Fastener according to claim 4, wherein said wing-shaped members have friction surfaces arranged, when said wing-shaped members are snapped out on said opposite side of the support from the faucet, to be in contact with said opposite side.

6. Fastener according to claim 5, wherein said surfaces are made of a rubber like material, preferably an elastomer.

7. Fastener according to claim 1, wherein said stop means comprises a flange arranged to stop against the faucet side of the support.

8. Fastener according to claim 7, wherein said flange is covered with a rubber packing.
